(19) United States
(12) Patent Application Publication
(10) Pub. No.: US 2026/0291113 A1
(43) Pub. Date: Sep. 24, 2026

(54) CONNECTOR

(71) Applicant: YAZAKI CORPORATION, Tokyo (JP)

(72) Inventors: Kotatsu Shibayama, Kakegawa-shi, Shizuoka (JP); Yoshitaka Tsushima, Kakegawa-shi, Shizuoka (JP); Shoya Ueda, Kakegawa-shi, Shizuoka (JP)

(21) Appl. No.: 19/562,726

(22) Filed: Mar. 10, 2026

(30) Foreign Application Priority Data
Mar. 19, 2025 (JP) 2025-045550

(51) Int. Cl. H01R 13/502; H01R 13/424; H01R 13/52

(52) U.S. Cl. CPC H01R 13/502; H01R 13/424; H01R 13/5205

(57) ABSTRACT

A connector includes a housing including a cylindrical fitting portion, a rear case, a terminal holder, at least one terminal of which a tip end side is held inside the cylindrical fitting portion in a state where a base end side of the terminal is held by the terminal holder, and at least one electric wire cord having one end side joined to the base end side of the at least one terminal and the other end side led out to the outside of the rear case through a hole portion provided in the rear case. The other end side of the at least one electric wire cord is led out to the outside of the rear case through the hole portion provided outside the one end side of the at least one electric wire cord in the radial direction of the rear case.

### BACKGROUND OF THE INVENTION

### Field of the Invention

Aspects of the present disclosure relate to a connector.

Priority is claimed on Japanese Patent Application No. 2025-045550 filed in Japan on Mar. 19, 2025, the content of which is incorporated herein by reference.

### Description of Related Art

For example, a wide variety of electronic devices are mounted on an automobile as a moving body. In an automobile, electrical connection with an electronic device is performed via a connector in order to transmit power, a control signal, and the like to the electronic device.

In general, a connector includes a housing including a cylindrical fitting portion that protrudes in a cylindrical shape in a direction in which the connector is fitted to a mating connector, a terminal having a tip end side held inside the cylindrical fitting portion, and an electric wire cord having one end side joined to a base end side of the terminal and the other end side led out to the outside of the housing through a hole portion provided in the housing. In addition, the connector employs a waterproofing structure in which a seal member attached to the periphery of the electric wire cord is fitted inside the hole portion.

For example, a connector described in Patent Document 1 includes a connector housing provided with a terminal fitting and a terminal accommodating chamber, and a rear holder attached to an end portion of the connector housing on a side away from a mating connector. The terminal accommodating chamber includes a connection portion accommodating portion that accommodates an electric wire connection portion of the terminal fitting, a contact portion accommodating portion that is continuous with the connection portion accommodating portion and accommodates an electrical contact portion of the terminal fitting and is smaller than the connection portion accommodating portion, and a step surface formed between the connection portion accommodating portion and the contact portion accommodating portion. The electric wire connection portion of the terminal fitting is provided with a flange portion that protrudes from the outer peripheral surface of the electric wire connection portion and can come into contact with the step surface. A sleeve member is accommodated in the connection portion accommodating portion of the terminal accommodating chamber and is provided between the flange portion and the rear holder.

### PRIOR ART DOCUMENT

### Patent document

Patent Document 1: Japanese Unexamined Patent Application, First Publication No. 2010-055809

### SUMMARY OF THE INVENTION

Incidentally, in the connector of the related art, since the terminal and the electric wire cord are coaxially joined, an adjacent interval between a plurality of terminals and an adjacent interval between a plurality of electric wire cords are equal to each other.

For this reason, in the connector of the related art, in a case where the adjacent interval on the terminal side is made decreased for the requirement for miniaturization, it is difficult to make the adjacent interval on the electric wire cord side be decreased due to the above-described waterproofing structure, and a space for arranging the seal member in the housing cannot be secured.

On the other hand, in a case where the adjacent interval on the electric wire cord side is made increased than the adjacent interval on the terminal side, the central axis on the tip end side of the terminal and the central axis on the other end side of the electric wire cord do not match with each other across the joined portion between the base end side of the terminal and the one end side of the electric wire cord.

In this case, it is difficult to hold the terminal inside the housing in a stable state, and the robustness of the connector is deteriorated.

An aspect of the present disclosure provides a connector capable of securing a space on an electric wire cord side other than a terminal side and holding a terminal in a stable state.

A connector according to an aspect of the present disclosure includes a housing including a cylindrical fitting portion that protrudes in a cylindrical shape in a direction in which the connector is fitted to a mating connector, a rear case assembled on a side opposite to the cylindrical fitting portion of the housing, a terminal holder disposed between the housing and the rear case, at least one terminal of which a tip end side is held inside the cylindrical fitting portion in a state where a base end side of the terminal is held by the terminal holder, and at least one electric wire cord having one end side joined to the base end side of the at least one terminal and the other end side led out to the outside of the rear case through a hole portion provided in the rear case. The other end side of the at least one electric wire cord is led out to the outside of the rear case through the hole portion provided outside the one end side of the at least one electric wire cord in the radial direction of the rear case.

In the connector according to the aspect of the present disclosure, it is possible to secure a space on the electric wire cord side other than the terminal side and to hold the terminal in a stable state.

### BRIEF DESCRIPTION OF THE DRAWINGS

FIG. 1 is a perspective view illustrating a constitution of a connector according to an embodiment of the present disclosure.

FIG. 2 is an exploded perspective view illustrating the constitution of the connector illustrated in FIG. 1.

FIG. 3 is a perspective view illustrating a state before a housing and a rear case of the connector illustrated in FIG. 1 are assembled.

FIG. 4 is a cross-sectional view illustrating a state before the housing and the rear case of the connector illustrated in FIG. 3 are assembled.

FIG. 5 is an enlarged cross-sectional view of a main part of the connector illustrated in FIG. 4.

### DETAILED DESCRIPTION OF THE INVENTION

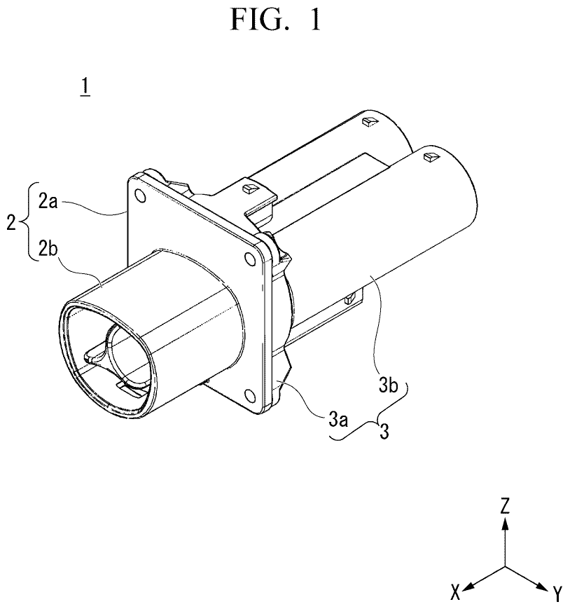

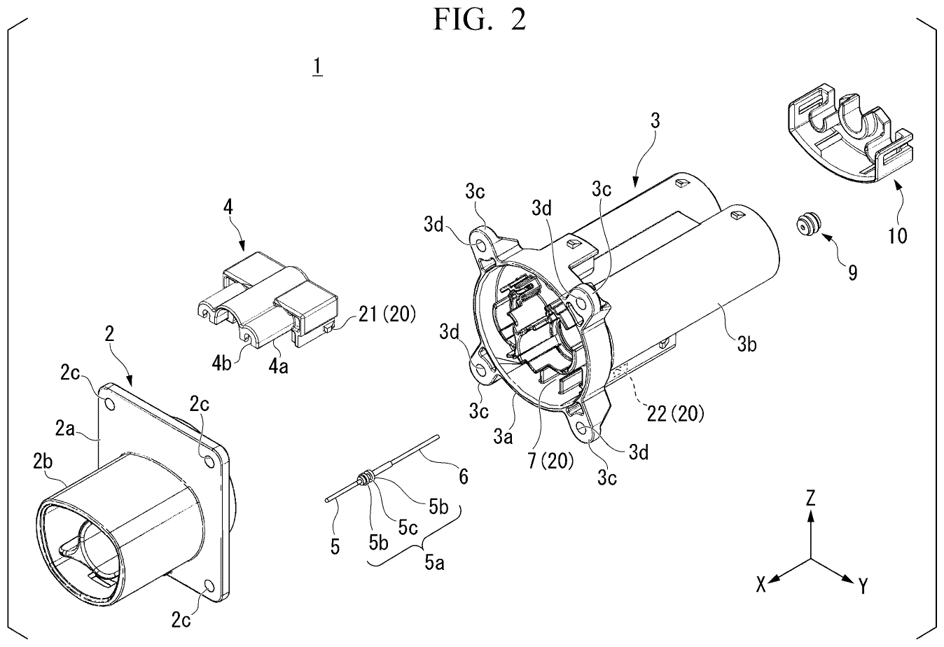

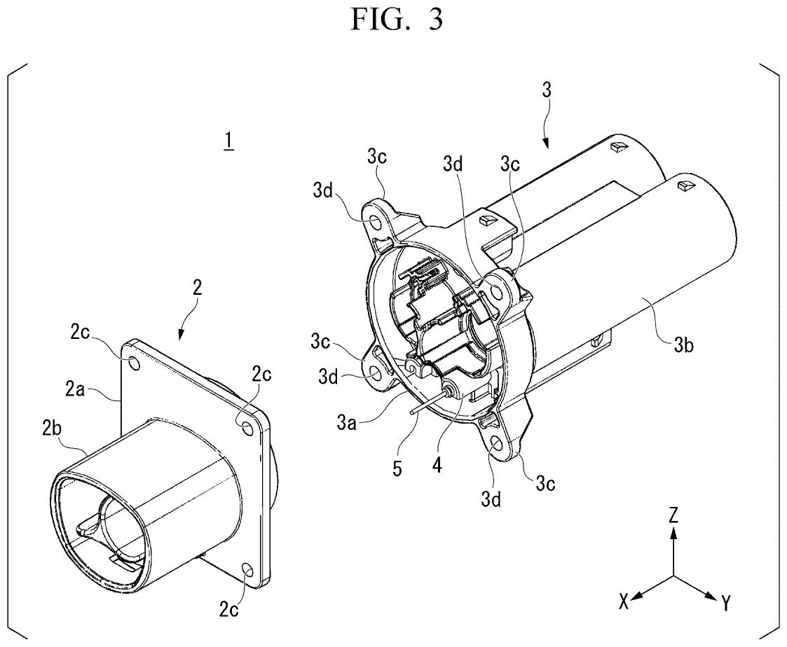

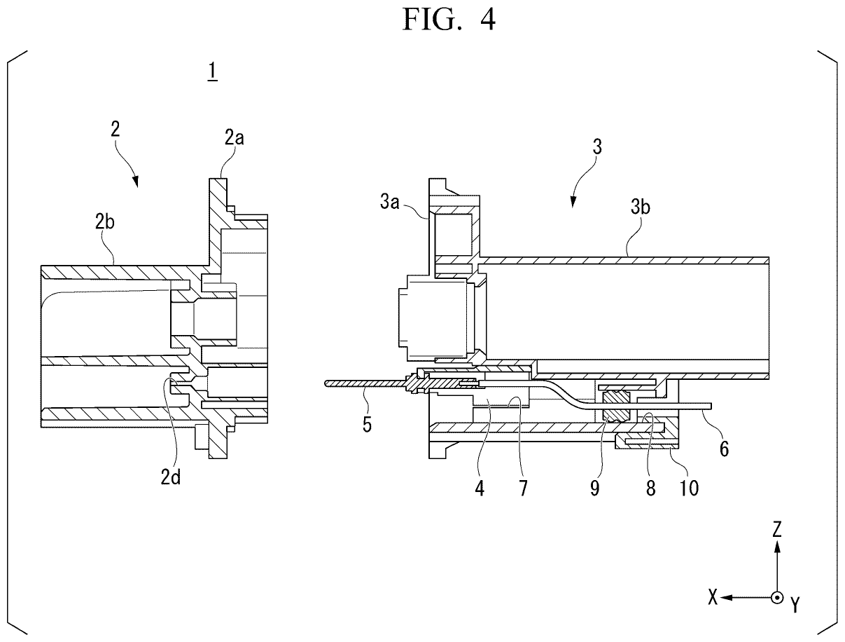

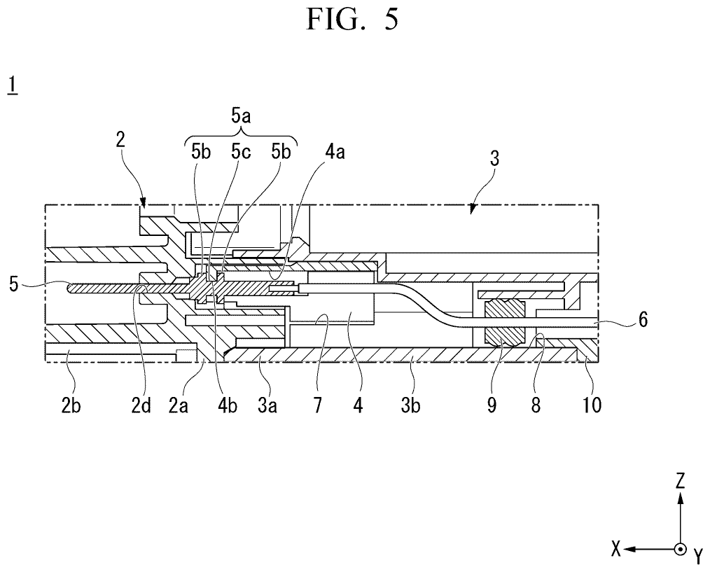

As an embodiment of the present disclosure, for example, a connector 1 illustrated in FIGS. 1 to 5 will be described. FIG. 1 is a perspective view illustrating a constitution of the connector 1. FIG. 2 is an exploded perspective view illustrating the constitution of the connector 1. FIG. 3 is a perspective view illustrating a state before a housing 2 and a rear case 3 of the connector 1 are assembled. FIG. 4 is a cross-sectional view illustrating a state before the housing 2 and the rear case 3 of the connector 1 are assembled. FIG. 5 is an enlarged cross-sectional view of a main part of the connector 1.

In addition, in the following drawings, an XYZ orthogonal coordinate system is set, and an X-axis direction is indicated as a front-rear direction of the connector 1, a Y-axis direction is indicated as a left-right direction of the connector 1, and a Z-axis direction is indicated as an up-down direction of the connector 1.

As illustrated in FIG. 1, the connector 1 of the present embodiment is fitted to a mating connector (not shown) to be electrically connected thereto. By electrically connecting the connectors to each other, electricity can be conducted between the connectors.

The connector 1 of the present embodiment constitutes a male (plug) connector to be inserted into a female (receptacle) connector, which is a mating connector.

In the present embodiment, a description will be given assuming that a first direction in which the connector 1 is inserted to the mating connector is a forward side (+X direction) of the connector 1, a direction opposite to the first direction is a rearward side (−X direction), a side facing the mating connector is the front side of the connector 1, and a side opposite thereto is the back side of the connector 1.

As illustrated in FIGS. 1 and 2, the connector 1 of the present embodiment includes the housing 2, the rear case 3, a terminal holder 4, a plurality of terminals 5, and a plurality of electric wire cords 6.

In the present embodiment, among the plurality of terminals 5 and electric wire cords 6, only one set of terminals 5 and electric wire cords 6 held by the terminal holder 4 is illustrated.

As illustrated in FIGS. 1 to 4, the housing 2 is made of a molded body of a synthetic resin. The housing 2 has a back wall 2a constituting the back side thereof and a cylindrical fitting portion 2b constituting the front side thereof.

The back wall 2a is formed in a substantially rectangular flat plate shape with rounded corners. Four attachment holes 2c are provided at four corners of the back wall 2a so as to pass through the back wall 2a in the front-rear direction.

The cylindrical fitting portion 2b is a portion to be fitted with the above-described mating connector. The cylindrical fitting portion 2b protrudes in a substantially elongated cylindrical shape from a central portion on the front side of the back wall 2a.

A plurality of terminal holding portions 2d corresponding to the plurality of terminals 5 are provided inside the housing 2. The terminal holding portion 2d is a portion where a tip end side of the terminal 5 is held. The terminal holding portion 2d is located inside the cylindrical fitting portion 2b and provided to pass through the back wall 2a in the front-rear direction.

As illustrated in FIGS. 1 to 4, the rear case 3 is made of a molded body of a synthetic resin. The rear case 3 includes a cylindrical front portion 3a having a substantially cylindrical shape and constituting the front side thereof, a cord lead-out portion 3b extending rearward from the cylindrical front portion 3a, a plurality of fixing pieces 3c protruding in a radial expansion direction from an outer peripheral surface on the front side of the cylindrical front portion 3a, and screw holes 3d passing through the respective fixing pieces 3c in the front-rear direction.

A fitting recess 7 into which the terminal holder 4 is fitted is provided inside the cylindrical front portion 3a. In the cord lead-out portion 3b, a plurality of hole portions 8 are provided so as to pass through the inside of the rear case 3 in the front-rear direction corresponding to the plurality of electric wire cords 6.

Four fixing pieces 3c are provided corresponding to four corners of the back wall 2a constituting the housing 2. Four screw holes 3d are provided corresponding to the four attachment holes 2c of the housing.

The connector 1 of the present embodiment has a structure in which the housing 2 and the rear case 3 are integrated by screwing screws (not shown) into the screw holes 3d through the attachment holes 2c in a state in which the back side of the back wall 2a and the front side of the cylindrical front portion 3a are abutted with each other.

As illustrated in FIGS. 2 to 4, the terminal holder 4 is made of a molded body of a synthetic resin. In the terminal holder 4, a plurality of holding grooves 4a are provided so as to extend in the front-rear direction (the axial direction of the terminal 5) corresponding to the plurality of terminals 5. On the front side of the terminal holder 4, an engagement protrusion 4b protruding in a radial reduction direction from the inner peripheral surface of each holding groove 4a is provided.

The terminal holder 4 is held inside the fitting recess 7 via a holding mechanism 20. The holding mechanism 20 includes a locking portion 21 provided on one of the terminal holder 4 and the rear case 3 (the terminal holder 4 in the present embodiment) and a locking-subjected portion 22 provided on the other thereof (the rear case 3 in the present embodiment).

The locking portion 21 includes a pair of locking protrusions that protrude outward from both left and right sides of the terminal holder 4. On the other hand, the locking-subjected portion 22 includes a pair of locking recesses (not shown) provided on the left and right side surfaces of the fitting recess 7.

In the holding mechanism 20, in a state where the terminal holder 4 is fitted into the fitting recess 7 from the front side of the rear case 3, the locking portion (locking protrusion) 21 is locked to the locking-subjected portion (locking recess) 22, so that the terminal holder 4 can be held inside the fitting recess 7.

The terminal holder 4 is disposed inside the housing 2 and the rear case 3 in a state where the housing 2 and the rear case 3 are integrated.

Regarding the holding mechanism 20, the present disclosure is not necessarily limited to the above-described constitution in which the locking portion 21 is provided on a side of the terminal holder 4 and the locking-subjected portion 22 is provided on a side of the rear case 3, and may have a constitution in which the locking portion 21 is provided on a side of the rear case 3 and the locking-subjected portion 22 is provided on a side of the terminal holder 4.

In addition, the locking portion 21 and the locking-subjected portion 22 are not limited to those constituted by the above-described locking protrusion and locking recess, and may have any constitution as long as the locking portion 21 is locked to the locking-subjected portion 22.

The terminal 5 is made of a metal conductor such as brass or copper and is formed in a long rod shape. On a base end side of the terminal 5, a covering portion 5a that covers a joined portion with the electric wire cord 6, a pair of flange portions 5b protruding in the radial expansion direction from the outer peripheral surface of the covering portion 5a, and an engagement recess 5c formed between the pair of flange portions 5b of the covering portion 5a are provided.

The base end side of the terminal 5 is held by the terminal holder 4 by engaging the engagement protrusion 4b with the engagement recess 5c in a state where the covering portion 5a is held inside the holding groove 4a.

On the other hand, as illustrated in FIG. 5, the tip end side of the terminal is held by the terminal holding portion 2d (housing 2) in a state of passing through the terminal holding portion 2d so as to face the inside of the cylindrical fitting portion 2b.

The electric wire cord 6 has a constitution in which an electric wire such as copper is covered with an insulating resin, for example. One end side of the electric wire cord 6 is joined to the base end side of the terminal 5 by crimping or the like. The electric wire cord 6 is disposed to extend in the front-rear direction inside the cord lead-out portion 3b (rear case 3).

On the other hand, the other end side of the electric wire cord 6 is led out from the rear to the outside of the cord lead-out portion 3b (rear case 3) through the hole portion 8. A packing 9 is attached to a rear end portion of the cord lead-out portion 3b (rear case 3) via a packing holder 10. The packing 9 is a seal member for waterproofing and is fitted inside the hole portion 8 in a state of being attached to the periphery of the electric wire cord 6.

In the connector 1 of the present embodiment, as illustrated in FIG. 5, the other end side of the above-described electric wire cord 6 is led out to the outside of the rear case 3 through the hole portion 8 provided outside the one end side of the electric wire cord 6 in the radial direction of the rear case 3. That is, in the connector 1 of the present embodiment, an adjacent interval on the other end side of the electric wire cords 6 is greater than an adjacent interval on the tip end side of the terminals 5.

With this constitution, in the connector 1 of the present embodiment, it is possible to secure a larger space on a side of the electric wire cord 6 of the rear case 3 than on a side of the terminal 5 of the housing 2. Therefore, in the connector 1 of the present embodiment, even when the adjacent interval on the side of the terminals 5 is made decreased for the requirement for miniaturization, the adjacent interval on the side of the electric wire cords 6 can be made increased without forming a complicated shape which is obtained by bending the terminals 5. Furthermore, it is possible to secure a space for arranging the packing 9 in the rear case 3.

In addition, in the connector 1 of the present embodiment, the terminal holder 4 holding the above-described terminal 5 is disposed between the housing 2 and the rear case 3. The terminal holder 4 is held inside the fitting recess 7 of the rear case 3 via the above-described holding mechanism 20.

With this constitution, in the connector 1 of the present embodiment, the terminal holder 4 is less likely to be affected by the outside, and the terminal 5 can be held in a stable state by the terminal holder 4. Furthermore, the robustness of the connector 1 can also be improved.

In addition, in the connector 1 of the present embodiment, the terminal holder 4 is held inside the fitting recess 7 in a stable state via the above-described holding mechanism 20.

With this constitution, in the connector 1 of the present embodiment, when the rear case 3 is assembled from a side (back side) opposite to the cylindrical fitting portion 2b of the housing 2, the tip end side of the terminal 5 can be inserted into the terminal holding portion 2d in a stable state, and the assembling workability of the rear case 3 with respect to the housing 2 can be improved.

In the above embodiment, the present invention is not necessarily limited to the constitution of the connector 1 described above, and the shapes and the like of the housing 2 and the rear case 3 can be appropriately changed. For example, the present invention can be applied not only to a straight-type connector in which the terminal 5 and the electric wire cord 6 extend in the same direction but also to an L-type connector in which the terminal 5 and the electric wire cord 6 extend in directions orthogonal to each other. In addition, the number, arrangement, and the like of the plurality of terminals 5 and electric wire cords 6 can be appropriately changed.

Although the embodiment of the present disclosure has been described and illustrated above, the above-described embodiment is illustrated as an example and is not intended to limit the scope of the present disclosure. The above-described embodiment can be implemented in various other forms, and various additions, omissions, substitutions, and modifications can be performed without departing from the gist of the disclosure.

### REFERENCE SIGNS LIST

1 Connector
2 Housing
3 Rear case
4 Terminal holder
5 Terminal
6 Electric wire cord
7 Fitting recess
8 Hole portion
9 Packing (seal member)
10 Packing holder
20 Holding mechanism
21 Locking portion
22 Locking-subjected portion

What is claimed is:

1. A connector comprising:
a housing including a cylindrical fitting portion that protrudes in a cylindrical shape in a direction in which the connector is fitted to a mating connector;
a rear case assembled on a side opposite to the cylindrical fitting portion of the housing;
a terminal holder disposed between the housing and the rear case;
at least one terminal of which a tip end side is held inside the cylindrical fitting portion in a state where a base end side of the terminal is held by the terminal holder; and
at least one electric wire cord having one end side joined to the base end side of the at least one terminal and the other end side led out to the outside of the rear case through a hole portion provided in the rear case,
wherein the other end side of the at least one electric wire cord is led out to the outside of the rear case through the hole portion provided outside the one end side of the at least one electric wire cord in the radial direction of the rear case.

2. The connector according to claim 1, wherein
a plurality of terminals and a plurality of electric wire cords are provided, and
an adjacent interval on the other end side of the plurality of electric wire cords is greater than an adjacent interval on the tip end side of the plurality of terminals.

3. The connector according to claim 1, further comprising a seal member fitted inside the hole portion in a state of being attached to a periphery of the at least one electric wire cord.

4. The connector according to claim 1, further comprising a holding mechanism that holds the terminal holder inside the rear case.

5. The connector according to claim 4, wherein the holding mechanism includes a fitting recess into which the terminal holder is fitted inside the rear case.

6. The connector according to claim 5, wherein
the holding mechanism includes a locking portion provided on one of the terminal holder and the rear case and a locking-subjected portion provided on the other of the terminal holder and the rear case, and
the locking portion is locked to the locking-subjected portion in a state where the terminal holder is fitted into the fitting recess.
